(19) United States
(12) Patent Application Publication
(10) Pub. No.: US 2024/0212935 A1
(43) Pub. Date: Jun. 27, 2024

(54) MULTILAYER ELECTRONIC COMPONENT

(71) Applicant: SAMSUNG ELECTRO-MECHANICS CO., LTD., Suwon-si (KR)

(72) Inventors: Hiroki OKADA, Suwon-si (KR); Jong Rock LEE, Suwon-si (KR); Jun Il KANG, Suwon-si (KR); Hee Jung JUNG, Suwon-si (KR); Chung Yeol LEE, Suwon-si (KR); Cheong KIM, Suwon-si (KR)

(73) Assignee: SAMSUNG ELECTRO-MECHANICS CO., LTD., Suwon-si (KR)

(21) Appl. No.: 18/124,713

(22) Filed: Mar. 22, 2023

(30) Foreign Application Priority Data
Dec. 22, 2022 (KR) 10-2022-0181457

(51) Int. Cl. H01G 4/232; H01G 4/224; H01G 4/252; H01G 4/30

(52) U.S. Cl. CPC H01G 4/2325; H01G 4/224; H01G 4/252; H01G 4/30

(57) ABSTRACT

A multilayer electronic component according to an example embodiment of the present disclosure may include a body including a dielectric layer and internal electrodes alternately arranged in a first direction with the dielectric layer between the internal electrodes, and including first and second surfaces opposing each other in the first direction, third and fourth surfaces connected to the first and second surfaces and opposing each other in a second direction, and fifth and sixth surfaces connected to the first to fourth surfaces and opposing each other in a third direction; external electrodes disposed on the body; and a first inorganic material, including at least one inorganic material among sulfur (S) and fluorine (F), disposed in at least a portion between the body and the external electrodes.

### CROSS-REFERENCE TO RELATED APPLICATION (S)

This application claims benefit of priority to Korean Patent Application No. 10-2022-0181457 filed on Dec. 22, 2022, in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser mounted on the printed circuit boards of various types of electronic products such as image display devices, including a liquid crystal display (LCD) and a plasma display panel (PDP), computers, smartphones, and mobile phones, and serves to charge or discharge electricity therein or therefrom.

The multilayer ceramic capacitor may be used as a component of various electronic devices due to having a small size, ensuring high capacitance and being easily mounted. With the miniaturization and high output power of various electronic devices such as computers and mobile devices, demand for miniaturization and high capacitance of multilayer ceramic capacitors has also been increasing.

Meanwhile, in order to achieve miniaturization and high capacitance of a multilayer electronic component at the same time, a method of using a material having a high dielectric ratio, reducing the thickness of a dielectric layer or an internal electrode layer, or thinning an external electrode may be used.

In this case, as a method of thinning the external electrode, there is provided a method of forming the external electrode with a plating film or a thin film deposition method such as sputtering, but due to insufficient bonding strength to a ceramic body, delamination between the body and the external electrode may occur, and due to material factors or a thin external electrode thickness, it may be difficult to implement sufficient mechanical strength. In addition, the body and/or external electrodes may have numerous pores, and since a thin film external electrode is thin, external moisture and a plating solution may be transmitted through the external electrode or may penetrate between bonding interfaces of the body and the external electrode, which may generate cracks or cause degradation of insulation resistance of the internal electrode.

### SUMMARY

An aspect of the present disclosure is to achieve miniaturization and high capacitance of a multilayer electronic component simultaneously, by forming a thin film external electrode layer.

An aspect of the present disclosure is to improve bonding force between a body and external electrodes.

An aspect of the present disclosure is to improve moisture resistance reliability by sealing pores present in a body or external electrodes.

However, the aspects of the present disclosure are not limited to the above-described contents, and may be more easily understood in the process of describing specific embodiments of the present disclosure.

According to an aspect of the present disclosure, a multilayer electronic includes: a body including a dielectric layer and internal electrodes alternately arranged in a first direction with the dielectric layer between the internal electrodes, and including first and second surfaces opposing each other in the first direction, third and fourth surfaces connected to the first and second surfaces and opposing each other in a second direction, and fifth and sixth surfaces connected to the first to fourth surfaces and opposing each other in a third direction; external electrodes disposed on the body; and a first inorganic material, including at least one inorganic material among sulfur (S) and fluorine (F), disposed in at least a portion between the body and the external electrodes.

According to another aspect of the present disclosure, a multilayer electronic includes: a body including a dielectric layer and internal electrodes with the dielectric layer between the internal electrodes; and an external electrode disposed on the body. The external electrode includes a first electrode layer disposed on the body to connect to one of the internal electrodes, and a second electrode layer disposed on the first electrode layer. The external electrode further includes an inorganic material, including one or more among sulfur (S), fluorine (F), silicon (Si), lithium (Li), and sodium (Na), dispersed in the first electrode layer.

According to an exemplary embodiment in the present disclosure, miniaturization and high capacitance of a multilayer electronic component are achieved at the same time by forming a thin film external electrode layer.

According to an exemplary embodiment in the present disclosure, bonding force between a body and external electrodes is improved.

According to an exemplary embodiment in the present disclosure, moisture resistance reliability is improved by sealing pores present in a body or external electrodes.

However, the various and beneficial advantages and effects of the present disclosure are not limited to the above-described contents, and may be more easily understood in the process of describing specific embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an example embodiment of the present disclosure;

FIG. 2 is an exploded perspective view schematically illustrating a stacked structure of internal electrodes of FIG. 1;

FIG. 3 is a schematic cross-sectional view taken along line II-II′ of FIG. 1;

FIG. 4 is a schematic cross-sectional view taken along line I-I′ of FIG. 1;

FIG. 5 is a schematic enlarged view of region P of FIG. 4;

FIG. 6 is a schematic cross-sectional view taken along line I-I′ of FIG. 1 according to another example embodiment of the present disclosure;

FIG. 7 is a schematic enlarged view of region P-1 of FIG. 6;

FIG. 8 is a schematic cross-sectional view taken along line I-I′ of FIG. 1 according to another example embodiment of the present disclosure;

FIG. 9 is a schematic enlarged view of region P-2 of FIG. 8;

FIG. 10 is a schematic cross-sectional view taken along line I-I′ of FIG. 1 according to another example embodiment of the present disclosure; and

FIG. 11 is a schematic enlarged view of region P-3 of FIG. 10.

### DETAILED DESCRIPTION

Hereinafter, embodiments of the present disclosure will be described with reference to specific example embodiments and the attached drawings. The embodiments of the present disclosure may, however, be exemplified in many different forms and should not be construed as being limited to the specific embodiments set forth herein. The example embodiments disclosed herein are provided for those skilled in the art to better explain the present disclosure. In the drawings, the shapes and dimensions of elements may be exaggerated for clarity, and the same reference numerals will be used throughout to designate the same or like elements.

In addition, in order to clearly describe the present disclosure in the drawings, the contents unrelated to the description are omitted, and since sizes and thicknesses of each component illustrated in the drawings are arbitrarily shown for convenience of description, the present disclosure is not limited thereto. In addition, components with the same function within the same range of ideas are described using the same reference numerals. Throughout the specification, when a certain portion “includes” or “comprises” a certain component, this indicates that other components are not excluded and may be further included unless otherwise noted.

In the drawings, a first direction may be defined as a thickness T direction, a second direction may be defined as a length L direction, and a third direction may be defined as a width W direction.

### Multilayer Electronic Component

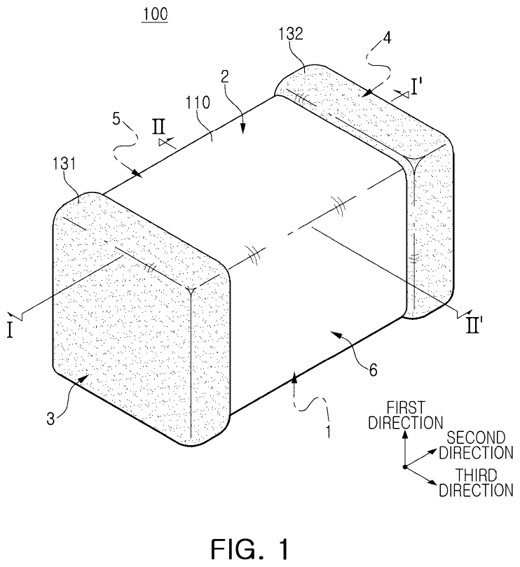

FIG. 1 is a perspective view schematically illustrating a multilayer electronic component according to an example embodiment of the present disclosure.

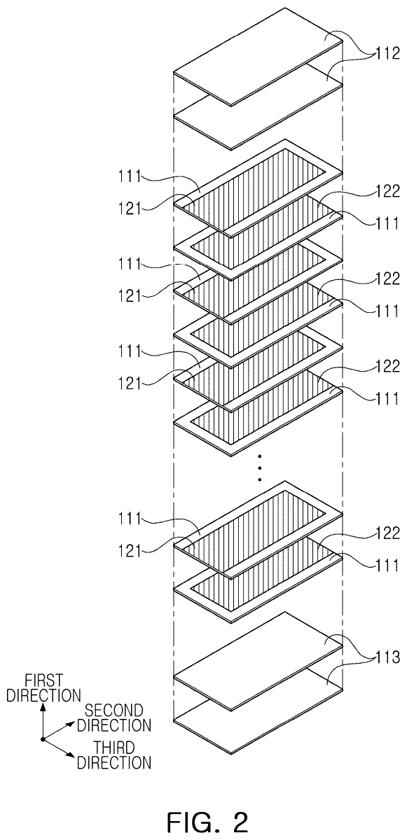

FIG. 2 is an exploded perspective view schematically illustrating a stacked structure of internal electrodes of FIG. 1.

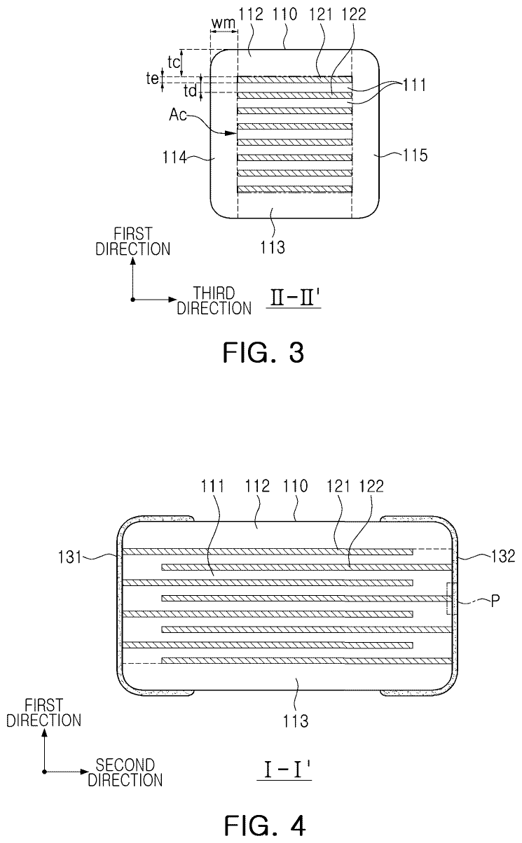

FIG. 3 is a schematic cross-sectional view taken along line II-II′ of FIG. 1.

FIG. 4 is a schematic cross-sectional view taken along line I-I′ of FIG. 1.

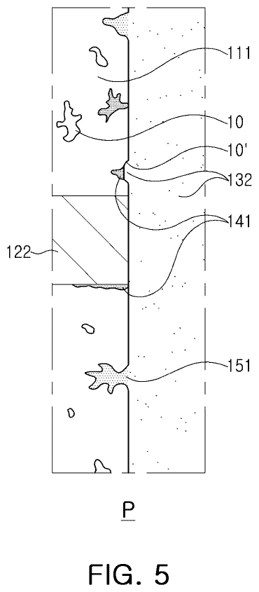

FIG. 5 is a schematic enlarged view of region P of FIG. 4.

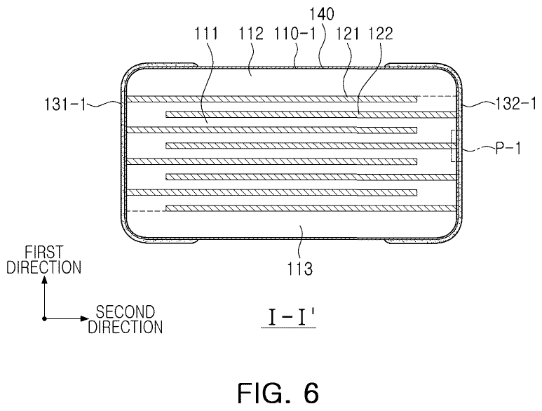

FIG. 6 is a schematic cross-sectional view taken along line I-I′ of FIG. 1 according to another example embodiment of the present disclosure.

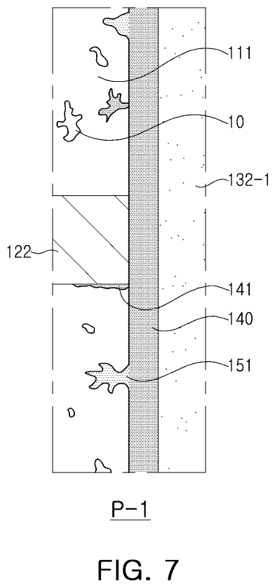

FIG. 7 is a schematic enlarged view of region P-1 of FIG. 6.

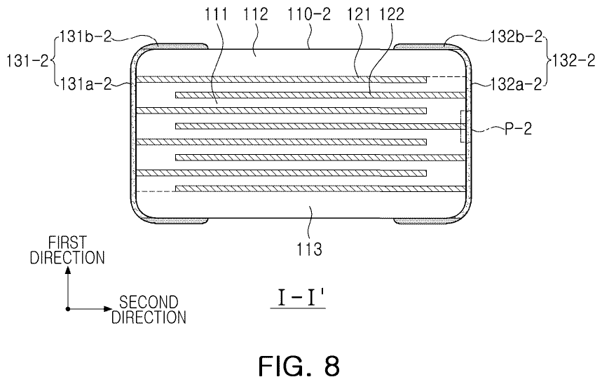

FIG. 8 is a schematic cross-sectional view taken along line I-I′ of FIG. 1 according to another example embodiment of the present disclosure.

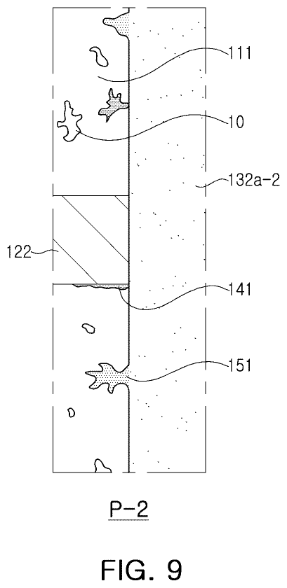

FIG. 9 is a schematic enlarged view of region P-2 of FIG. 8.

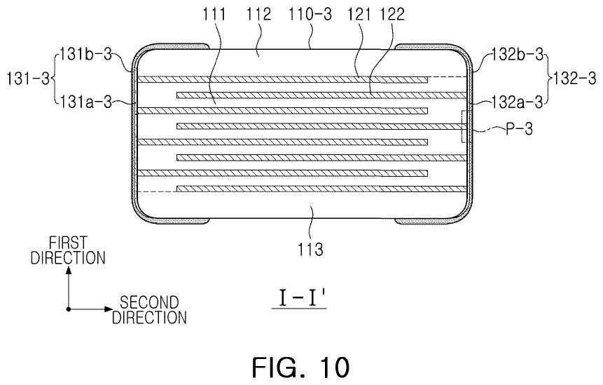

FIG. 10 is a schematic cross-sectional view taken along line I-I′ of FIG. 1 according to another example embodiment of the present disclosure. and

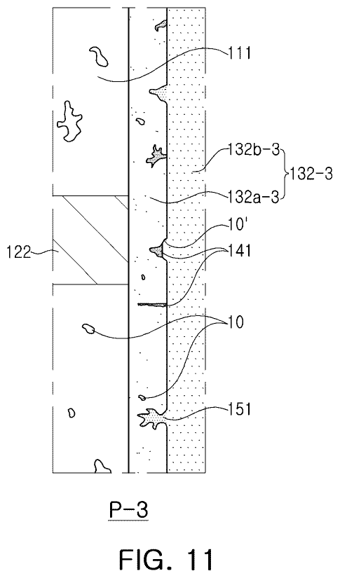

FIG. 11 is a schematic enlarged view of region P-3 of FIG. 10.

Hereinafter, with reference to FIGS. 1 to 11, the multilayer electronic component according to an example embodiment of the present disclosure will be described in detail. However, although a multilayer ceramic capacitor is described as an example of a multilayer electronic component, the present disclosure may be applied to various electronic products, for example, an inductor, a piezoelectric device, a varistor, a thermistor, or the like, using a dielectric composition.

A multilayer electronic component 100 according to an example embodiment of present disclosure includes: a body 110 including a dielectric layer 111 and internal electrodes 121 and 122 alternately arranged in the first direction with the dielectric layer 111, and including first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first, second, third and fourth surfaces 1, 2, 3 and 4 and opposing each other in the third direction; and external electrodes 131 and 132 disposed on the body 110, and a first inorganic material 141 including at least one inorganic material among sulfur (S) and fluorine (F) is disposed in at least a portion between the body 110 and the external electrodes 131 and 132.

In the body 110, the dielectric layer 111 and the internal electrodes 121 and 122 are alternately stacked with one another.

More specifically, the body 110 may include the first internal electrode 121 and the second internal electrode 122 disposed in the body 110 and alternately disposed to face each other with the dielectric layer 111 interposed therebetween, thus including a capacitance formation portion Ac for forming capacitance.

There is no particular limitation on the specific shape of the body 110, but as illustrated, the body 110 may have a hexahedral shape or a similar shape. Due to contraction of ceramic powder particles included in the body 110 during a sintering process, the body 110 may not have a hexahedral shape with completely straight lines, but may have a substantially hexahedral shape.

The body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first, second, third and fourth surfaces 1, 2, 3 and 4 and opposing each other in the third direction.

In a state in which a plurality of dielectric layers 111 forming the body 110 are sintered, boundaries between adjacent dielectric layers 111 may be so integrated so as to be difficult to identify without using a scanning electron microscope (SEM).

A raw material forming the dielectric layer 111 is not limited as long as it may obtain sufficient capacitance. In general, a perovskite (ABO₃)-based material may be used, and, for example, a barium titanate-based material, a lead composite perovskite-based material, or a strontium titanate-based material may be used. The barium titanate-based material may include BaTiO₃-based ceramic powder particles, and an example of the ceramic powder may include (Ba₁₋ₓCaₓ) TiO₃ (0<x<1), Ba(Ti_{1-y}Ca_{y}) O₃ (0<y<1), (Ba₁₋ₓCaₓ) (Ti_{1-y} Zr_{y}) O₃ (0<x<1, 0<y<1), or Ba(Ti_{1-y}Zr_{y}) O₃ (0<y<1) in which Ca (calcium) and Zr (zirconium) are partially included in BaTiO₃ and BaTiO₃.

In addition, as raw materials forming the dielectric layer 111, various ceramic additives, organic solvents, binders, dispersants, and the like may be added to powder particles formed of a material such as barium titanate (BaTiO₃), depending on the purpose of the present disclosure.

A thickness td of the dielectric layer 111 is not particularly limited.

However, in easily achieve order to more miniaturization and high capacitance of the multilayer electronic component, the thickness of the dielectric layer 111 may be 0.6 μm or less, and more preferably, 0.4 μm or less.

Here, the thickness td of the dielectric layer 111 may denote a thickness td of the dielectric layer 111 disposed between the first and second internal electrodes 121 and 122.

Meanwhile, the thickness td of the dielectric layer 111 may denote a size of the dielectric layer 111 in the first direction. In addition, the thickness td of the dielectric layer 111 may denote an average thickness td of the dielectric layers 111 and may denote an average size of the dielectric layer 111 in the first direction.

The average size of the dielectric layer 111 in the first direction may be measured by scanning an image of the first and second directional cross-sections of the body 110 with the scanning electron microscope (SEM) of 10,000× magnification. More specifically, the average size may be an average value obtained by measuring the size in the first direction at 30 points which are spaced from each other at equal intervals in the second direction in one dielectric layer 111 on the scanned images. The 30 points spaced from each other at equal intervals may be designated in the capacitance formation portion Ac. In addition, when the average value is measured by extending an average value measurement up to 10 dielectric layers 111, the average size of the dielectric layers 111 in the first direction may be further generalized.

The internal electrodes 121 and 122 may be alternately stacked with the dielectric layer 111.

The internal electrodes 121 and 122 may include a first internal electrode 121 and a second internal electrode 122, and the first and second internal electrodes 121 and 122 may be alternately disposed to face each other with the dielectric layer 111 constituting the body 110 interposed therebetween, and may be exposed to the third and fourth surfaces 3 and 4 of the body 110.

More specifically, the first internal electrode 121 may be spaced apart from the fourth surface 4 and exposed through (or be in contact with or extend from) the third surface 3, and the second internal electrode 122 may be spaced apart from the third surface 3 and exposed through (or be in contact with or extend from) the fourth surface 4. A first external electrode 131 may be disposed on the third surface 3 of the body 110 and be connected to the first internal electrode 121, and a second external electrode 132 may be disposed on the fourth surface 4 of the body 110 and be connected to the second internal electrode 122.

That is, the first internal electrode 121 may be connected to the first external electrode 131 without being connected to the second external electrode 132, and the second internal electrode 122 may be connected to the second external electrode 132 without being connected to the first external electrode 131. In this case, the first and second internal electrodes 121 and 122 may be electrically separated from each other by a dielectric layer 111 disposed therebetween.

Meanwhile, the body 110 may be formed by alternately stacking a ceramic green sheet on which the first internal electrode 121 is printed and a ceramic green sheet on which the second internal electrode 122 is printed, and then sintering the ceramic green sheets.

A material forming the internal electrodes 121 and 122 is not particularly limited, and a material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

In addition, the internal electrodes 121 and 122 may be formed by printing a conductive paste for internal electrodes including at least one of nickel (Ni), copper (Cu), palladium (Pd), silver (Ag), gold (Au), platinum (Pt), tin (Sn), tungsten (W), titanium (Ti), and alloys thereof on a ceramic green sheet. A method of printing the conductive paste for the internal electrodes may include a screen-printing method or a gravure printing method, and the present disclosure is not limited thereto.

Meanwhile, a thickness te of the internal electrodes 121 and 122 is not particularly limited.

However, in order to more easily achieve miniaturization and high capacitance of the multilayer electronic component, the thickness of the internal electrodes 121 and 122 may be 0.6 μm or less, and more preferably, 0.4 μm or less.

Here, the thickness te of the internal electrodes 121 and 122 may denote the size of the internal electrodes 121 and 122 in the first direction. In addition, the thickness te of the internal electrodes 121 and 122 may denote an average thickness te of the internal electrodes 121 and 122 and may denote an average size of the internal electrodes 121 and 122 in the first direction.

The average size of the internal electrodes 121 and 122 in the first direction may be measured by scanning an image of the first and second directional cross-sections of the body 110 with the scanning electron microscope (SEM) of 10,000× magnification. More specifically, the average size may be an average value obtained by measuring the size in the first direction at 30 points which are spaced from each other at equal intervals in the second direction in one internal electrode 121 or 122 on the scanned images. The 30 points spaced from each other at equal intervals may be designated in the capacitance formation portion Ac. In addition, when the average value is measured by expanding an average value measurement up to 10 internal electrodes 121 and 122, the average size of the internal electrodes 121 and 122 in the first direction may be further generalized.

Meanwhile, the body 110 may include cover portions 112 and 113 disposed on opposite end-surface surfaces of the capacitance formation portion Ac in the first direction.

More specifically, the body 110 may include an upper cover portion 112 disposed above the capacitance formation portion Ac in the first direction and a lower cover portion 113 disposed below the capacitance formation portion Ac in the first direction.

The upper cover portion 112 and the lower cover portion 113 may be formed by stacking a single dielectric layer 111 or two or more dielectric layers 111 on upper and lower surfaces of the capacitance formation portion Ac in the first directions, and may basically serve to prevent damage to the internal electrodes 121 and 122 due to physical or chemical stress.

The upper cover portion 112 and the lower cover portion 113 do not include the internal electrodes 121 and 122 and may include the same material as the dielectric layer 111. That is, the upper cover portion 112 and the lower cover portion 113 may include a ceramic material, for example, a barium titanate (BaTiO₃)-based ceramic material.

Meanwhile, a thickness tc of the cover portions 112 and 113 is not particularly limited.

However, in order to more easily achieve miniaturization and high capacitance of the multilayer electronic components, the thickness tc of the cover portions 112 and 113 may be 100 μm or less, preferably 30 μm or less, and more preferably 20 μm or less in ultra-small products.

Here, the thickness tc of the cover portions 112 and 113 may denote the size of the cover portions 112 and 113 in the first direction. In addition, the thickness tc of the cover portions 112 and 113 may denote an average thickness tc of the cover portions 112 and 113 and may denote an average size of the cover portions 112 and 113 in the first direction.

The average size of the cover portions 112 and 113 in the first direction may be measured by scanning an image of the first and second directional cross-sections of the body 110 with the scanning electron microscope (SEM) of 10,000× magnification. More specifically, the average size may be an average value obtained by measuring the thickness at 30 points which are spaced apart from each other at equal intervals in the second direction in one cover portion on the scanned image. The 30 points spaced from each other at equal intervals may be designated in the upper cover portion 112.

Meanwhile, side margin portions 114 and 115 may be disposed on opposite end-surface surfaces of the body 110 in the third direction.

More specifically, the side margin portions 114 and 115 may include a first side margin portion 114 disposed on the fifth surface 5 of the body 110 and a second side margin portion 115 disposed on the sixth surface 6. That is, the side margin portions 114 and 115 may be disposed on opposite end-surface surfaces of the body 110 in the third direction.

As illustrated, the side margin portions 114 and 115 may refer to a region between opposite ends of the first and second internal electrodes 121 and 122 in the third direction and a boundary surface of the body 110 with respect to the second and third directional cross-sections of the body 110.

The side margin portion 114 and 115 may basically serve to prevent damage to the internal electrodes 121 and 122 due to physical or chemical stress.

The side margin portions 114 and 115 form the internal electrodes 121 and 122 by applying a conductive paste on the ceramic green sheet except for an area where the side margin portions 114 and 115 will be formed, and in order to suppress a step portion of the internal electrodes 121 and 122, after the stacked internal electrodes 121 and 122 are cut to be exposed to the fifth and sixth surfaces 5 and 6 of the body 110, a single dielectric layer 111 or two or more dielectric layers 111 may be stacked and formed in the third direction on opposite end-surface surfaces of the capacitance formation portion Ac in the third direction.

The first side margin portion 114 and the second side margin portion 115 do not include the internal electrodes 121 and 122 and may include the same material as the dielectric layer 111. That is, the first side margin portion 114 and the second side margin portion 115 may include a ceramic material, for example, a barium titanate (BaTiO₃)-based ceramic material.

Meanwhile, a width wm of the first and second side margin portions 114 and 115 is not particularly limited.

However, in order to more easily achieve miniaturization and high capacitance of the multiplayer electronic component 100, the width wm of the side margin portions 114 and 115 may be 100 μm or less, preferably 30 μm or less, and more preferably 20 μm or less in ultra-small products.

Here, the width wm of the side margin portions 114 and 115 may refer to a size of the side margin portions 114 and 115 in the third direction. In addition, the width wm of the side margin portions 114 and 115 may denote an average width wm of the side margin portions 114 and 115, and may denote an average size of the side margin portions 114 and 115 in the third direction.

The average size of the side margin portions 114 and 115 in the third direction may be measured by scanning an image of the first and third directional cross-sections of the body 110 with the scanning electron microscope (SEM) of 10,000× magnification. More specifically, the average size may be an average value obtained by measuring the size in the third direction at 30 points which are spaced apart from each other at equal intervals in the first direction on the scanned image. The 30 points spaced from each other at equal intervals may be designated in the side margin portion 114.

Although an example embodiment of the present disclosure describes a structure in which the ceramic electronic component 100 has two external electrodes 131 and 132, the number or shape of the external electrodes 131 and 132 may be changed according to the shape of the internal electrodes 121 and 122 or other purposes.

The external electrodes 131 and 132 may be disposed on the body 110 and may be connected to the internal electrodes 121 and 122.

More specifically, the external electrodes 131 and 132 may include first and second external electrodes 131 and 132 disposed on the third and fourth surfaces 3 and 4 of the body 110 and connected to the first and second internal electrodes 121 and 122, respectively. That is, the first external electrode 131 may be disposed on the third surface 3 of the body and may be connected to the first internal electrode 121, and the second external electrode 132 may be disposed on the fourth surface 4 of the body and be connected to the second internal electrode 122.

A region of the external electrodes 131 and 132 disposed on the third and fourth surfaces 3 and 4 of the body and connected to the internal electrodes 121 and 122 may be defined as a connection portion, and a region thereof disposed on the first, second, fifth, and sixth surfaces 1, 2, 5 and 6 of the body may be defined as a band portion.

In this case, the band portion may mean a shape extending from the connection portion and disposed on at least a partial region of the first, second, fifth, and sixth surfaces 1, 2, 5 and 6.

More specifically, a region of the first external electrode 131 disposed on the third surface 3 of the body and connected to the first internal electrode 121 may be defined as a first connection portion, and a region thereof extending from the first connection portion and disposed on at least some of the first, second, fifth, and sixth surfaces 1, 2, 5 and 6 of the body may be defined as a first band portion.

A region of the second external electrode 132 disposed on the fourth surface 4 of the body and connected to the second internal electrode 122 may be defined as a second connection portion, and a region thereof extending from the second connection portion and disposed on at least some of the first, second, fifth, and sixth surfaces 1, 2, 5 and 6 of the body may be defined as a second band portion.

The external electrodes 131 and 132 may be formed of any material as long as they have electrical conductivity such as metal, and as the material of the external electrodes 131 and 132, a specific material may be determined in consideration of electrical characteristics, structural stability, and the like, and also, the external electrodes 131 and 132 may have a multi-layer structure.

For example, the external electrodes 131 and 132 may include an electrode layer disposed on the body 110 and plating layers 131b and 132b disposed on the electrode layer.

For a more specific example of the electrode layer, the electrode layer may be a sintered electrode including a conductive metal and glass, or a resin-based electrode including a conductive metal and a resin.

In addition, the electrode layer may have a form in which the sintered electrode and the resin-based electrode are sequentially formed on the body 110.

In addition, the electrode layer may be formed in a way of transferring a sheet including a conductive metal on the body 110, and may be formed in a way of transferring a sheet including the conductive metal on the sintered electrode.

The conductive metal used in the electrode layer is not particularly limited as long as it can be electrically connected to the internal electrodes 121 and 122 to form capacitance, and may include at least one selected from the group consisting of nickel (Ni), copper (Cu), palladium (Pd), silver (Ag), gold (Au), platinum (Pt), tin (Sn), tungsten (W), titanium (Ti), and alloys thereof. The electrode layer may be formed by applying a conductive paste prepared by adding a glass frit to the conductive metal powder particles and then sintering the conductive paste.

Meanwhile, in order to more easily decrease the thickness of the external electrodes 131 and 132, the external electrodes 131 and 132 may include a first electrode layer using a sputtering method or a second electrode layer using a plating method.

When the first electrode layer is formed by using the sputtering method, the first electrode layer having a relatively uniform thickness may be formed on the outside of the body 110, and at the same time, the occurrence of pores may be small to have excellent moisture resistance reliability.

The thickness of the first electrode layer is not particularly limited. However, in order to miniaturize the multilayer electronic component, the thickness of the first electrode layer may be 10 nm or more and 1 μm or less.

When the thickness of the first electrode layer is less than 10 nm, sufficient conductivity may be difficult to realize, or the moisture resistance reliability may be reduced, and delamination may occur at an interface between the body 100 and the external electrodes 131 and 132. When the thickness of the first electrode layer exceeds 1 μm, it may be difficult to achieve miniaturization of the multilayer electronic component.

Here, the thickness of the first electrode layer may be measured using the scanning electron microscope (SEM), and the thickness of the first electrode layer may refer to an average thickness. For example, the thickness thereof may be an average value obtained by measuring a size perpendicular to a surface of a body at any three points among each surface of the formed body in the region where the first electrode layer is disposed.

More specifically, based on the first and second directional cross-sections at a ½ point of the body in the third direction, a value obtained by measuring and averaging a second directional size at a center point of a first directional size of the connection portion of the first electrode layer and at both points spaced apart from the center point in the first direction by a predetermined interval may correspond to an average thickness of the connection portion of the first electrode layer. In addition, a value obtained by measuring and averaging a first directional size at a center point of a second directional size of a first electrode layer band portion disposed on the first surface or the second surface and at both points spaced apart from the center point in the second direction by a predetermined may correspond to an average thickness of the first electrode layer band portion.

When the second electrode layer is formed by using the plating method, the second electrode layer having a relatively uniform thickness may be formed on the outside of the body 110, and at the same time, the occurrence of pores may be small to have excellent moisture resistance reliability.

The thickness of the second electrode layer is not particularly limited. However, in order to miniaturize the multilayer electronic component, the thickness of the second electrode layer may be 10 nm or more and 1 μm or less.

When the thickness of the second electrode layer is less than 10 nm, sufficient conductivity may be difficult to realize, or the moisture resistance reliability may be reduced, and delamination may occur at an interface between the body 100 and the external electrodes 131 and 132. When the thickness of the second electrode layer exceeds 1 μm, it may be difficult to achieve miniaturization of the multilayer electronic component.

More specifically, based on the first and second directional cross-sections at the ½ point of the body in the third direction, a value obtained by measuring and averaging a second directional size at a center point of a first directional size of the connection portion of the second electrode layer and at both points spaced apart from the center point in the first direction by a predetermined interval may correspond to an average thickness of the connection portion of the second electrode layer. In addition, a value obtained by measuring and averaging a first directional size at a center point of a second directional size of a second electrode layer band portion disposed on the first surface or the second surface and at both points spaced apart from the center point in the second direction by a predetermined interval may correspond to an average thickness of the second electrode layer band portion.

A plating layer may be disposed on the electrode layer. The plating layer disposed on the electrode layer serves to improve mounting characteristics.

The type of plating layer is not particularly limited, and may be a single plating layer including at least one of nickel (Ni), tin (Sn), palladium (Pd), and alloys thereof, or may be formed of a plurality of layers.

For a more specific example, the plating layer may be a Ni plating layer or a Sn plating layer, and may have a form in which the Ni plating layer and the Sn plating layer may be sequentially formed on the electrode layer, and a form in which the Sn plating layer, the Ni plating layer, and the Sn plating layer may be sequentially formed. In addition, the plating layer may include a plurality of Ni plating layers and/or a plurality of Sn plating layers.

Meanwhile, in order to achieve miniaturization and high capacitance of the multilayer electronic component at the same time, a method of using a material with a high dielectric constant, reducing the thickness of a dielectric layer or an internal electrode layer, or thinning an external electrode is used.

As described above, in one method of forming the external electrode, a paste for external electrodes may be applied and may be subject to a heat treatment to form a sintered electrode layer, but the sintered electrode layer electrode layer may have difficulty realizing a thin film thickness of an external electrode required by ultra-small products. Accordingly, as a method of thinning an external electrode, there may be a method of forming an external electrode into a plating film, and a thin film deposition method such as sputtering, but insufficient bonding strength to a ceramic body may result in delamination between the body and the external electrode, and due to a material factor or a thin thickness of the external electrode, it may be difficult to implement sufficient mechanical strength. In addition, the body or the external electrode may have numerous pores, but since the thin film external electrode is thin, the external moisture and plating solution may be transmitted through the external electrode or penetrate through a bonding interface between the body and the external electrode, which may cause cracks or degrade insulation resistance of the internal electrodes.

Hereinafter, an example embodiment of the present disclosure will be described in more detail.

In the multilayer electronic component 100 according to an example embodiment of the present disclosure, a first inorganic material 141 including at least one inorganic material among sulfur (S) and fluorine (F) may be disposed between the body 110 and the external electrodes 131 and 132.

In addition, a second inorganic material 151 including at least one inorganic material among silicon (Si), lithium (Li), and sodium (Na) may be disposed between the body 110 and the external electrodes 131 and 132.

More specifically, pores 10 may be present in an internal portion and on an external surface of the body 110 disposed close to the external electrodes 131 and 132, and the first inorganic material 141 or the second inorganic material 151 may seal the pores 10 present in the internal portion and on the external surface of the body. In other words, the first inorganic material or the second inorganic material may be disposed in the pores 10.

In this case, the pores 10 may include micropores having an average diameter of 1 nm or more and 100 nm or less or ultrafine pores having an average diameter of less than 1 nm.

For example, the first inorganic material by a plasma method may be better disposed in pores having a diameter of 100 nm or less, and a lower limit thereof is not particularly limited, but the first inorganic material may be disposed at a position where an atom may be disposed regardless of the size of the pores.

The second inorganic material by a vacuum impregnation method may be disposed in pores having a diameter of 1 nm or more, and an upper limit thereof is not separately limited, but it may be difficult for the second inorganic material to penetrate through the pores having a diameter of less than 1 nm by vacuum pressure.

Here, the average diameter size of the pores may refer to an average size of a minimum diameter size and a maximum diameter size passing through a center point of the diameter.

Meanwhile, in the present disclosure, the pores formed on the external surface of the body may not have a circular shape, and the diameter of the pores may be determined based on an inlet of the pores. For example, in FIG. 5, the inlet of micropores may be relatively wide, while the inlet of ultrafine pores may be relatively narrow, and an interior of the pores may be wider than the inlet of the pores. The diameter of the pores formed on the external surface of the body may refer to a diameter of a pore inlet based on the first and second directional cross-sections of the body, and for example, the diameter size of the pore inlet formed on the external surfaces of the third and fourth surfaces 3 and 4 of the body may refer to a first direction size of the pore inlet. In addition, the diameter size of the pore inlet formed on the third and fourth surfaces of the body may refer to a value obtained by averaging a minimum diameter size and a maximum diameter size of the pore inlet measured based on the second and third directional cross-sections.

The first inorganic material 141 or the second inorganic material 151 may be measured using energy dispersive X-ray spectroscopy (EDS).

More specifically, based on the first and second directional cross-sections at the ½ point of the multilayer electronic component in the third direction, a region between the body and the external electrode may observed and confirmed. In this case, a scanning electron microscope (SEM) of 10,000× magnification or a transmission electron microscope (TEM) may be used during the observation, and after mapping elements corresponding to the first inorganic material or the second inorganic material by an EDS analysis, a point at which the element is detected may be analyzed with a point-EDS, or the pores formed on the external surface of the body may be measured to check whether the first inorganic material or the second inorganic material is detected, but the present disclosure is not particularly limited thereto.

Meanwhile, the first inorganic material 141 may be disposed using the plasma method.

For example, a plasma treatment may be advanced using sulfur (S) or fluorine (F) on an external surface of a ceramic green sheet stacked body formed by stacking ceramic green sheets before forming the external electrode. Basically, plasma may be deposited on a ceramic body by reacting with only the ceramic body without reacting with metal, for example copper (Cu) or nickel (Ni). Since the plasma method has excellent permeability, it is possible to seal ultrafine pores having a smaller size than micropores.

In addition, when treating the body 110 with the plasma method, fine roughness is formed on a surface thereof, which can improve adhesion between the body 110 and the external electrodes 131 and 132.

As illustrated in the drawings, for the fine roughness formed on the surface of the body, a surface roughness 10′ may be formed in the body by the plasma method, and although not illustrated in the drawings, the first inorganic material may be stacked outside the body to form surface roughness.

The first inorganic material 141 has excellent bonding strength with ceramic, and when the first inorganic material 141 is disposed while forming the surface roughness from an external surface of the body 110 to an interior or exterior of the body, the adhesion between the body 110 and the external electrodes 131 and 132 can be improved. That is, there is an effect of suppressing the occurrence of interface delamination between the body 110 and the external electrodes 131 and 132 by the first inorganic material 141.

The second inorganic material 151 may be disposed using a vacuum impregnation method.

For example, the second inorganic material 151 may be disposed by performing a vacuum impregnation treatment using an impregnation agent in which at least one inorganic material among silicon (Si), lithium (Li), and sodium (Na) is included in the ceramic green sheet stacked body formed by stacking the ceramic green sheet before forming the external electrode. When the ceramic green sheet stacked body is subject to the vacuum impregnation method, the second inorganic material 151 may fill not only the pores 10 formed on an external surface of the ceramic body but also the pores formed in the body near the surface thereof.

In conventional technology, a coating layer is formed of an organic material including a silane-based or a carbon compound to seal pores formed on a surface of the body, thereby imparting water repellency to the surface of the body, but in the case of an organic material, unintended pores may be additionally formed due to gasification (for example, CO₂) of carbon (C) during a sintering process, or cracks may be formed because gas provides the body to some shock while the gas is discharged from the body.

In the present disclosure, since the pores are sealed using an inorganic material other than an organic material, the moisture resistance moisture resistance reliability may be improved and the external electrode layer may be thinned, and at the same time, the above-described carbon (C) may not be gasified in the sintering process, thereby suppressing additional pore formation or crack occurrence.

When the second inorganic material 151 is formed on the surface of the body 110 using the vacuum impregnation method, the external electrodes 131 and 132 may be formed as a first electrode layer using the sputtering method.

For the second inorganic material 151, it may be difficult to form a second electrode layer on the body using a plating method, and since a plating treatment may be required by adsorbing a lead (Pd) catalyst, the process may be complicated. Accordingly, when the second inorganic material 151 is disposed below the external electrodes 131 and 132, the first electrode layer may be formed.

The multilayer electronic component 100 according to an example embodiment of the present disclosure may include a coating layer 140 disposed on at least a portion of the external surface of the body 110.

More specifically, the coating layer 140 may be disposed between the body 110 and the external electrodes 131-1 and 132-1, may be disposed in at least a portion of a region in which the external electrodes 131-1 and 132-1 are not disposed, and may be disposed in all regions in which the external electrodes 131-1 and 132-1 are not disposed. That is, as illustrated in FIG. 6, the entire external surface of the body 110 may be surrounded by the coating layer 140.

In this case, the coating layer 140 may include the first inorganic material 141 or the second inorganic material 151.

For example, the coating layer 140 may be formed by covering the external surface of the body with the first inorganic material 141, the coating layer 140 may be formed by covering the external surface of the body with the second inorganic material 151, and the first inorganic material 141 and the second inorganic material 151 may be formed by stacking the first inorganic material 141 and the second inorganic material 151 regardless of the order thereof.

The coating layer 140 may effectively seal the pores formed on the surface of the body and simultaneously prevent the penetration of external moisture, thus having more excellent moisture resistance reliability.

In this case, the thickness of the coating layer 140 is not particularly limited.

When the coating layer 140 includes the first inorganic material, since the first inorganic material in a collision region is substituted with copper due to an impact of copper (Cu) ions accompanied upon forming a sputtering electrode layer, the thickness of the coating layer 140 is sufficient as long as it may be formed to be less than or equal to a thickness of the sputtering electrode layer.

In addition, when the coating layer 140 includes the second inorganic material, the thickness of the coating layer 140 may be adjusted through a washing process, and if necessary, all second inorganic materials formed outside the body may be removed. Even in this case, the second inorganic material disposed in the pores may not be removed even after a washing process, thereby maintaining excellent moisture resistance reliability.

In order to achieve miniaturization of the multilayer electronic component 100, the upper limit of the coating layer 140 may be preferably 1 μm or less, but the present disclosure is not particularly limited thereto, and the moisture resistance reliability is not reduced.

A method for measuring a thickness or an average thickness of the coating layer 140 may be performed using the scanning electron microscope (SEM), and the method therefor is the same as the method for measuring the thickness of the electrode layer described above, and thus will be omitted.

Hereinafter, various embodiments of the present disclosure will be described.

Referring to FIGS. 4 and 5 according to one embodiment of the present disclosure, the first inorganic material 141 or the second inorganic material 151 may be disposed in the pores present on the external surface of the body.

In the present disclosure, disposition of the first inorganic material 141 or the second inorganic material 151 may include sealing the pores 10.

More specifically, when only the plasma method is used, only the first inorganic material may be disposed, when only the vacuum impregnation method is used, only the second inorganic material may be placed, and when the plasma method is used after using the vacuum impregnation method, or the vacuum impregnation method is used after using the plasma method, both the first and second inorganic materials may be disposed.

When the first inorganic material is disposed, it may seal up to ultrafine pores, the surface roughness 10′ may be formed by the plasma method, and the first inorganic material may be filled. Although not illustrated in the drawings, as described above, the first inorganic material may be stacked on the outside of the body to form the surface roughness.

When the first inorganic material is disposed, the external electrode may be formed of any one selected from the first electrode layer and the second electrode layer, but when only the second inorganic material is disposed, the external electrode may be formed of the first electrode layer.

Referring to FIGS. 6 and 7 according to another example embodiment of the present disclosure, the first inorganic material 141 or the second inorganic material 151 may be sealed in the pores present on the external surface of the body, and the coating layer 140 may be formed on the external surface of the body.

More specifically, when only the plasma method is used, the coating layer 140 may be formed while the first inorganic material 141 is disposed in the pores 10 including ultrafine pores, and when only the vacuum impregnation method is used, the coating layer 140 may be formed while the second inorganic material 151 is disposed in the pores 10. Then, the coating layer 140 may include the first inorganic material 141 or the second inorganic material 151 according to methods, and the coating layer 140 may be formed by stacking the first and second inorganic materials regardless of the order thereof.

When an external layer of the coating layer 140 is formed of the first inorganic material 141, the external electrodes 131-1 and 132-1 may be formed of any one selected from the first electrode layer and the second electrode layer, but when the external layer of the coating layer 140 is formed of the second inorganic material 151, the external electrode may be formed as the first electrode layer.

Referring to FIGS. 8 and 9, according to another example embodiment of the present disclosure, methods for forming connection portions 131a-2 and 132a-2 and band portions 131b-2 and 132b-2 of the external electrodes 131-2 and 132-2 may be different.

For example, the connection portions 131a-2 and 132a-2 may be formed of the first electrode layer, the band portions 131b-2 and 132b-2 may be formed of the second electrode layer, and conversely, the connection portions 131a-2 and 132a-2 may be formed of the second electrode layer, and the band portions 131b-2 and 132b-2 may be formed of the first electrode layer.

As described above, the external surface of the body 110 on which the first electrode layer is formed may include at least one selected from the first inorganic material 141 and the second inorganic material 151, but the first inorganic material may be disposed on the external surface of the body 110 on which the second electrode layer is formed.

Referring to FIGS. 10 and 11, according to another example embodiment of the present disclosure, methods for forming electrode layers of the connection portions 131a-2 and 132a-2 and the band portions 131b-2 and 132b-2 of the external electrodes 131-3 and 132-3 may be different, and the electrode layers may be formed to cover upper surfaces of connection portions 131a-3 and 132a-3 in the same method as the method for forming the electrode layers of the band portions.

For example, the connection portions 131a-3 and 132a-3 may be formed of the second electrode layer, and band portions 131b-3 and 132b-3 may be formed of the first electrode layer, and in this case, the first electrode layer may be further disposed to cover the connection portions 131a-3 and 132a-3. Conversely, the connection portions 131a-3 and 132a-3 may be formed of the first electrode layer, and the band portions 131b-3 and 132b-3 may be formed of the second electrode layer, and in this case, the second electrode layer may be further disposed to cover the connection portions 131a-3 and 132a-3.

As described above, the first inorganic material 141 may be disposed on the external surface of the body 110 on which the second electrode layer is formed, but at least one selected from the first inorganic material 141 and the second inorganic material 142 may be disposed on the external surface of the body 110 on which the first electrode layer is formed.

Meanwhile, before forming the connection portions 131a-3 and 132a-3 and forming the band portions 131b-3 and 132b-3, the first inorganic material 141 may be disposed on the connection portions 131a-3 and 132a-3 using the plasm method, or the second inorganic material 151 may be disposed on the connection portions 131a-3 and 132a-3 using the vacuum impregnation method.

For example, before the connection portion 131a-3 and 132a-3 are formed of the second electrode layer and the band portions 131b-3 and 132b-3 are formed of the first electrode layer, the first inorganic material 141 or the second inorganic material 151 is disposed on the connection portions 131a-3 and 132a-3 and the body 110, and then, the band portions 131b-3 and 132b-3 may be formed of the first electrode layer. Conversely, before the connection portions 131a-3 and 132a-3 are formed of the first electrode layer and the band portions 131b-3 and 132b-3 are formed of the second electrode layer, the second inorganic material 151 is disposed on the connection portions 131a-3 and 132a-3 and the body 110, and then, the band portions 131b-3 and 132b-3 may be formed of the second electrode layer.

The present disclosure is not limited to the above-described embodiments and the accompanying drawings, and is intended to be limited by the appended claims. Therefore, those of ordinary skill in the art may make various replacements, modifications, or changes without departing from the scope of the present invention defined by the appended claims, and these replacements, modifications, or changes should be construed as being included in the scope of the present invention.

In addition, the expression ‘one embodiment’ used in the present disclosure does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

The term used herein is for the purpose of describing particular embodiments only and is not intended to be limiting of the present disclosure. The singular also includes the plural unless specifically stated otherwise in the phrase.

What is claimed is:

1. A multilayer electronic component, comprising:
a body including a dielectric layer and internal electrodes alternately arranged in a first direction with the dielectric layer between the internal electrodes, and including first and second surfaces opposing each other in the first direction, third and fourth surfaces connected to the first and second surfaces and opposing each other in a second direction, and fifth and sixth surfaces connected to the first to fourth surfaces and opposing each other in a third direction;
external electrodes disposed on the body; and
a first inorganic material, including at least one inorganic material among sulfur (S) and fluorine (F), disposed in at least a portion between the body and the external electrodes.

2. The multilayer electronic component according to claim 1, wherein pores are present on an external surface of the body disposed below the external electrodes, and the first inorganic material is disposed in the pores.

3. The multilayer electronic component according to claim 2, wherein the pores include pores having an average diameter of less than 1 nm.

4. The multilayer electronic component according to claim 1, further comprising a second inorganic material, including at least one inorganic material among silicon (Si), lithium (Li), and sodium (Na), disposed between the body and the external electrodes.

5. The multilayer electronic component according to claim 4, wherein pores are present on an external surface of the body disposed below the external electrodes, and the second inorganic material is disposed in the pores.

6. The multilayer electronic component according to claim 1, further comprising a coating layer disposed on an external surface of the body,
wherein the coating layer includes the first inorganic material.

7. The multilayer electronic component according to claim 6, wherein the coating layer is disposed between the body and the external electrodes and in at least a portion of a region in which the external electrodes are not disposed.

8. The multilayer electronic component according to claim 1, wherein the external electrodes comprise a first electrode layer disposed on the third and fourth surfaces of the body, respectively, and a second electrode layer being in contact with the first electrode layer and disposed on at least a portion of the first, second, fifth, and sixth surfaces of the body, respectively.

9. The multilayer electronic component according to claim 8, wherein the second electrode layer is further disposed to cover the first electrode layer.

10. The multilayer electronic component according to claim 9, wherein the external electrodes comprise the first inorganic material therein.

11. The multilayer electronic component according to claim 10, wherein the first inorganic material is disposed between the first electrode layer and the second electrode layer.

12. The multilayer electronic component according to claim 1, wherein the external electrodes comprise a second electrode layer disposed on the third and fourth surfaces of the body, respectively, and a first electrode layer extending from the second electrode layer and disposed on at least a portion of the first, second, fifth, and sixth surfaces of the body.

13. The multilayer electronic component according to claim 12, wherein the first electrode layer is further disposed to cover the second electrode layer.

14. The multilayer electronic component according to claim 13, wherein the external electrodes comprise a second inorganic material including at least one inorganic material among silicon (Si), lithium (Li), and sodium (Na) therein.

15. The multilayer electronic component according to claim 14, wherein the second inorganic material is disposed between the second electrode layer and the first electrode layer.

16. The multilayer electronic component according to claim 1, wherein the first inorganic material is disposed on an external surface of the body to have surface roughness.

17. A multilayer electronic component, comprising:
a body including a dielectric layer and internal electrodes with the dielectric layer between the internal electrodes; and
an external electrode disposed on the body,
wherein the external electrode comprises a first electrode layer disposed on the body to connect to one of the internal electrodes, and a second electrode layer disposed on the first electrode layer, and
the external electrode further comprises an inorganic material, including one or more among sulfur (S), fluorine (F), silicon (Si), lithium (Li), and sodium (Na), dispersed in the first electrode layer.

18. The multilayer electronic component according to claim 17, wherein pores are present on the first electrode layer, and the inorganic material is disposed in the pores.

19. The multilayer electronic component according to claim 17, wherein the second electrode layer is in contact with the inorganic material and the first electrode layer.

20. The multilayer electronic component according to claim 17, wherein the first electrode layer includes a sintered electrode including a conductive metal and glass, or a resin-based electrode including a conductive metal and a resin, and
the second electrode layer includes a plating layer.
